(19) United States
(12) Patent Application Publication
(10) Pub. No.: US 2013/0335668 A1
(43) Pub. Date: Dec. 19, 2013

(54) Front Frame and Liquid Crystal Display Device

(71) Applicant: GuoFu Tang, Shenzhen (CN)

(72) Inventor: GuoFu Tang, Shenzhen (CN)

(73) Assignee: SHENZHEN CHINA STAR OPTOELECTRONICS TECHNOLOGY CO, LTD., Shenzhen (CN)

(21) Appl. No.: 13/521,741

(22) PCT Filed: Jun. 18, 2012
(86) PCT No.: PCT/CN12/77070

§ 371 Date: Jul. 12, 2012

(30) Foreign Application Priority Data
Jun. 13, 2012 (CN) 201210194832.2

(51) Int. Cl. G02F 1/1333

(52) U.S. Cl. 349/58

(57) ABSTRACT

The present invention provides a front frame for use with a liquid crystal display device, and includes a rectangular enclosure configured by sidewalls and extensions extending and bending from an inner edge of the sidewalls. Wherein four corners of the rectangular enclosure are round corners. The present invention further provides a liquid crystal display incorporated with the front frame disclosed above. The front frame and the liquid crystal display device can readily reduce its component by providing a sidewall with round and chamfered corners. The purpose of narrowed boarder can be readily realized, while the aesthetic appearance as well as the quality will not be compromised.

### FIELD OF THE INVENTION

The present invention relates to a technology of liquid crystal display, and more particularly, to a front frame of the liquid crystal display. and a liquid crystal display device incorporated with such a front frame.

### DESCRIPTION OF PRIOR ART

In the design of the liquid crystal display device, a front frame has been used to position the liquid crystal display panel so as to prevent it from falling apart. Referring to FIG. 1, an illustrational and structural view of a prior art front frame. The front frame 100 generally includes a sidewall 101 and an extension 102 and jointly define a rectangular enclosure: When the front frame 100 is formed, four corners of the sidewalls 101 have a cutout 1011. In order to cover those cutouts 1011, a blinding tap is deployed along the surface of the sidewalls 101. Substantially, please referring to FIG. 2 which is an illustrational and structural view of a prior art liquid crystal display device. In liquid crystal display device has incorporated with the front frame disclosed in FIG. 1. In order to keep an aesthetic appearance of the liquid crystal display device, an external frame 103 made from clear and transparent material has to be attached thereto so as to cover up. However, the front frame 100 is generally made with dark color, while the external frame 103 has a transparent property. Inevitably, this creates a visual illusion that the liquid crystal display device has a narrowed boarder, but in fact, the liquid crystal display does not reach to the requirements of the narrowed boarder.

### SUMMARY OF THE INVENTION

It is the main purpose of the present invention to provide a technical solution to a front frame and a liquid crystal display device incorporated with such a front frame so as to achieve the requirement of narrowed boarder.

In order to resolve the technical issue encountered by the prior art, the present invention provides a front frame for use with a liquid crystal display device, and includes a rectangular enclosure configured by sidewalls and extensions extending and bending from an inner edge of the sidewalls. Wherein four corners of the rectangular enclosure are round corners, and the sidewalls are provided with at least one threaded hole, wherein the sidewalls and the extensions are all made from sheet metal.

In order to resolve the technical issue of prior art, the present invention provides a front frame for use with a liquid crystal display device, and includes a rectangular enclosure configured by sidewalls and extensions extending and bending from an inner edge of the sidewalls, wherein four corners of the rectangular enclosure are chamfered corners.

Wherein the chamfered corners are round corners.

Wherein the sidewalls and the extensions are made from sheet metal.

Wherein the sidewalls and the extensions are made from sheet metal.

In order to resolve the technical issue encountered by the prior art, the present invention further provides a liquid crystal display device which includes a liquid crystal display panel, a backframe and a front frame disclosed previously. The liquid crystal display panel has a light emitting surface and a bottom surface opposite to the light emitting surface. The backframe includes a backboard and a bending portion extending from edges of the backboard toward the liquid crystal display panel. The backboard and bending portion are arranged adjacent to the bottom surface of the liquid crystal display panel. Wherein the sidewall is attached to the bending portion and the extension presses against the light emitting surface of the liquid crystal display panel.

Wherein a portion of the sidewall which is distant to the extension extends beyond the bottom of the backboard.

Wherein the liquid crystal display device further includes a protective lid attached to the backboard, the protective lid is defined with a receiving slot along edge for receiving the portion of the sidewall.

Wherein the portion of the sidewall which is distant to the bending portion flushes with the side of the protective lid.

Wherein the sidewall is attached to the bending portion by means of screw.

Wherein the sidewall has a hook arranged adjacent to the surface of the bending portion, wherein the bending portion is defined with a retaining slot corresponding to the hook, the sidewall is attached to the bending portion by engagement between the hook and the retaining slot.

In conclusion, the present invention can be concluded with the following advantages: as compared to the existing technology, the front frame and the liquid crystal display device can readily reduce its component by providing a sidewall with round and chamfered corners. The purpose of narrowed boarder can be readily realized, while the aesthetic appearance as well as the quality will not be compromised.

The above described is merely a primary disclosure. In order to readily clarify the technical solution, and therefore implement that technical solution in view of the specification, a detailed description in view of a preferable embodiment in conjunction with accompanied drawings will be given herebelow. By this, other purposes, features and characteristics can be readily appreciated through the detailed description.

### BRIEF DESCRIPTION OF DRAWINGS

FIG. 1 is an illustrational and structural view of a prior art front frame;

FIG. 2 an illustrational and structural view of a prior art liquid crystal display device;

FIG. 3 is a first embodiment of a front frame made in accordance with the present invention;

FIG. 4 is a front elevational view of a liquid crystal display device made in accordance with a second embodiment of the present invention;

FIG. 5 is a partial and cross sectional view of the liquid crystal display device shown in FIG. 4; and

FIG. 6 is a partial and cross sectional view of the liquid crystal display device made in accordance with a third embodiment of the present invention.

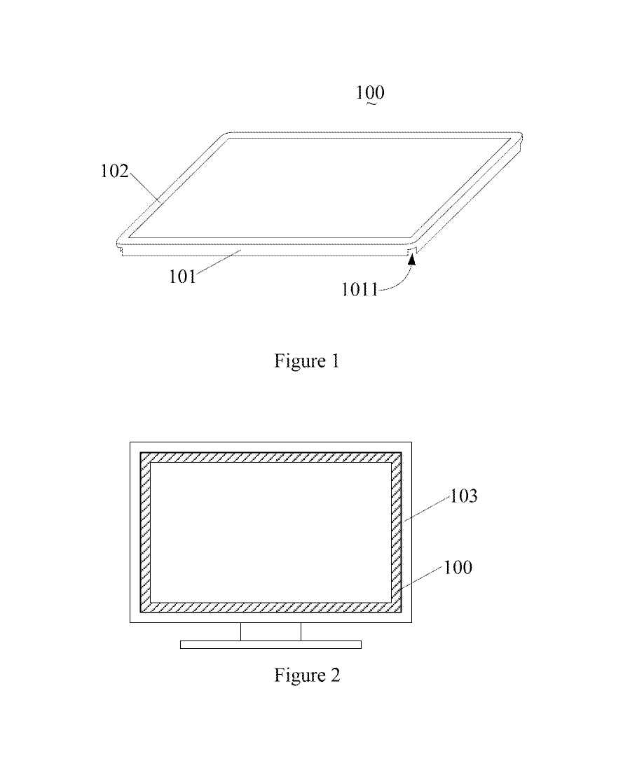

### DETAILED DESCRIPTION OF PREFERRED EMBODIMENT

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings.

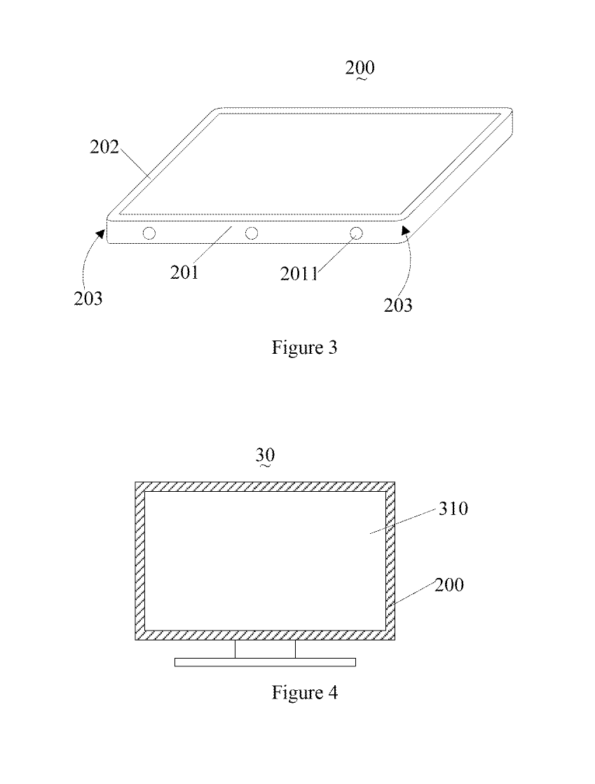

Referring to FIG. 3 which is a first embodiment of a front frame made in accordance with the present invention.

The front frame 200 includes a rectangular enclosure configured by sidewalls 201, and extension 202 extending inward from edge of the sidewall 201. The sidewall 201 has four chamfered corners 203. In the present invention, the chamfered corners 203 are round corners. The radius of the chamfered corner 203 can be determined according to the field requirements. At least one threaded hole 2011 is defined in the sidewall 201 for positioning and other intended function during assembling of the liquid crystal display.

In making the front frame 200, the sidewall 201 and the extension 202 can be integrally formed by stamping process. Then the four corners of the sidewall 201 can be readily rounded off so as to form a smooth and chamfered corner. Finally, the front frame 200 can be coated with a layer of painting. The extension 202 of the sidewall 201 does not need to coat with a layer of painting so as to reduce the cost. In addition, the sidewall 201 and the extension 202 can be made from sheet metal so as to reduce the thickness of the front frame to an extreme limit.

Referring to FIG. 4 which is a front elevational view of a liquid crystal display device made in accordance with a second embodiment of the present invention. The front frame 200 disclosed in the first embodiment can be incorporated in the liquid crystal display device of this embodiment.

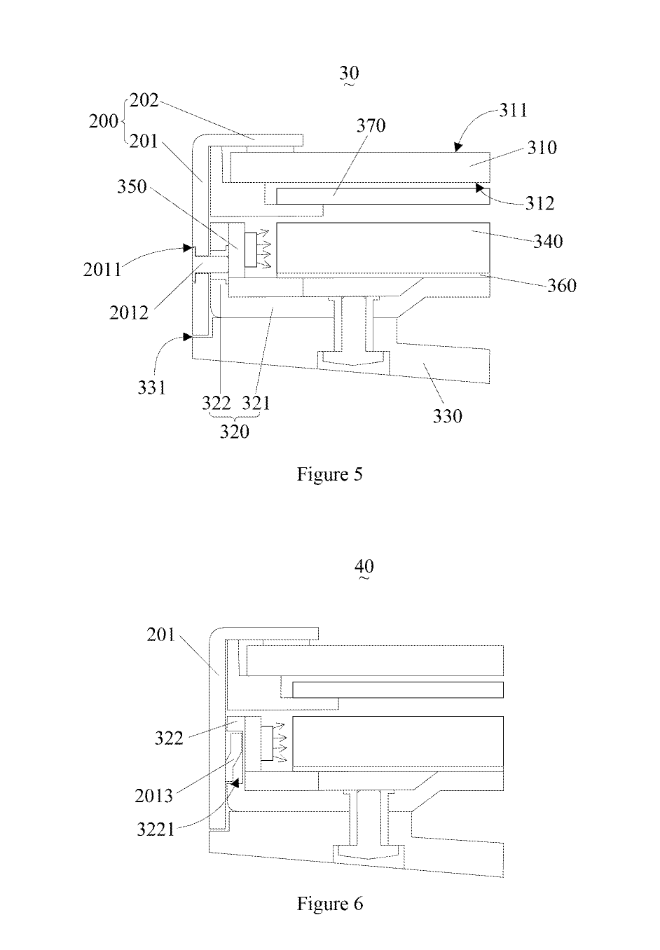

The liquid crystal display device 30 includes a front frame 200 and a liquid crystal display panel 310. Please also refer to FIG. 5 which is a partial and cross sectional view of the liquid crystal display device shown in FIG. 4. The liquid crystal display device 30 further includes a backframe 320, a protective lid 330, a waveguide 340, a LED light source 350, a refractive film 360, and an optical film 370.

The liquid crystal display panel 310 has a light emitting surface 311 and a bottom surface 312 opposite to the light emitting surface 311. The backframe 320 includes a backboard 321 and a bending portion 322 extending from edges of the backboard 321 toward the liquid crystal display panel 310. The backboard 321 and the bending portion 322 are arranged adjacent to the bottom surface 310 of the liquid crystal display panel 310. The sidewall 210 of the front frame 200 is attached to the bending portion 322, while the extension 202 presses against the light emitting surface 311 of the liquid crystal display panel 310. Substantially, the refractive film 360 is arranged above the backboard 321. The waveguide 340 is arranged above the refractive film 360. The optical film 370 is arranged above the waveguide 340 and close to the bottom surface 312 of the liquid crystal display panel 310. The LED light source 350 is arranged to a side of the waveguide 340 and the emitted light from the LED light source 350 is directly projected toward the side surface of the waveguide 340.

A portion of the sidewall 201 which is distant to the extension 202 extends beyond the bottom of the backboard 321. Substantially, the protective lid 330 is attached to the backboard 321. It can be attached thereto by screws or glue or any other suitable means. The protective lid 330 is provided with a slot 331 for receiving the portion of the sidewall 201 extending beyond the backboard 321. The portion of the sidewall 201 which is distant to the bending portion 322 flushes with the side of the protective lid 330.

A screw 2012 passes through the threaded hole 2011 so as to attach the sidewall 201 to the bending portion 322. By now, the assembling of the liquid crystal display device 30 is completed. No need to increase additional parts, such as the external frame used in the prior art. Accordingly, the present invention can readily realize the requirement of narrowed boarder.

Referring now to FIG. 6 which is a partial and cross sectional view of the liquid crystal display device made in accordance with a third embodiment of the present invention. A liquid crystal display device 40 is disclosed and which incorporates identical parts as disclosed in the second embodiment. Their relationships between the parts are also identical. Accordingly, no details are given herebelow. Wherein, the sidewall 201 and the bending portion 322 are snapped together. Substantially, the procedures will be disclosed as below.

The sidewall 201 has a hook 2013 arranged adjacent to the surface of the bending portion 322. The hook 2013 can be formed individually, and then welded to the sidewall 201. Alternatively, the hook 2013 can be formed directly and integrally with the sidewall 201. The bending portion 322 is defined with a retaining slot 3221 corresponding to the hook 2013. When the hook 2013 is engaged with the retaining slot 3221, the engagement between the sidewall 201 and the bending portion is completed.

By the description and disclosure introduced above, the front frame and the liquid crystal display device can readily reduce its component by providing a sidewall with round and chamfered corners. The purpose of narrowed boarder can be readily realized, while the aesthetic appearance as well as the quality will not be compromised.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A front frame for use with a liquid crystal display device, including a rectangular enclosure configured by sidewalls and extensions extending and bending from an inner edge of the sidewalls, wherein four corners of the rectangular enclosure are round corners, and the sidewalls are provided with at least one threaded hole, wherein the sidewalls and the extensions are all made from sheet metal.

2. A front frame for use with a liquid crystal display device, including a rectangular enclosure configured by sidewalk and extensions extending and bending from an inner edge of the sidewalls, wherein four corners of the rectangular enclosure are chamfered corners.

3. The front frame as recited in claim 2, wherein the chamfered corners are round corners.

4. The front frame as recited in claim 2, wherein the sidewalls are defined with at least one threaded hole.

5. The front frame as recited in claim 2, wherein the sidewalls and the extensions are made from sheet metal.

6. A liquid crystal display device including
a liquid crystal display panel having a light emitting surface and a bottom surface opposite to the light emitting surface;
a backframe including a backboard and a bending portion extending from edges of the backboard toward the liquid crystal display panel, the backboard and bending portion being arranged adjacent to the bottom surface of the liquid crystal display panel;
wherein the liquid crystal display panel includes a front frame including a rectangular enclosure configured by sidewalls and extensions extending and bending from an inner edge of the sidewalls,
wherein four comers of the rectangular enclosure are chamfered corners, wherein the sidewall is attached to the bending portion, and the extension presses against the light emitting surface of the liquid crystal display panel.

7. The liquid crystal display device as recited in claim 6, wherein a portion of the sidewall which is distant to the extension extends beyond the bottom of the backboard.

8. The liquid crystal display device as recited in claim 7, wherein the liquid crystal display device further includes a protective lid attached to the backboard, the protective lid is defined with a receiving slot along edge for receiving the portion of the sidewall.

9. The liquid crystal display device as recited in claim 8, wherein the portion of the sidewall which is distant to the bending portion flushes with the side of the protective lid.

10. The liquid crystal display device as recited in claim 6, Wherein the sidewall is attached to the bending portion by means of screw.

11. The liquid crystal display device as recited in claim 6, wherein the sidewall has a hook arranged adjacent to the surface of the bending portion, wherein the bending portion is defined with a retaining slot corresponding to the hook, the sidewall is attached to the bending portion by engagement between the hook and the retaining slot.
